(19) United States
(12) Patent Application Publication
(10) Pub. No.: US 2026/0186848 A1
(43) Pub. Date: Jul. 2, 2026

(54) SYSTEMS AND METHODS FOR ACCURATE AND COMPUTATIONALLY EFFICIENT RESOURCE MATCHING

(71) Applicant: OPTUM, INC., Minnetonka, MN (US)

(72) Inventors: Melany J. Rabideau, Frederick, MD (US); Natalie Jean Lambert, Brownsburg, IN (US); Emily R. Weeks, Minneapolis, MN (US); Devon Marie Moynihan, Baltimore, MD (US); Kai Takeuchi, Raleigh, NC (US); Alan K. Lassiter, Knoxville, TN (US); Laura Kochevar, Saint Paul, MN (US)

(21) Appl. No.: 19/005,106

(22) Filed: Dec. 30, 2024

(51) Int. Cl. G06F 9/50

(52) U.S. Cl. CPC G06F 9/505

(57) ABSTRACT

Techniques for accurately and efficiently assessing compatibility between resource users (e.g., patients) and resources (e.g., healthcare providers, facilities having certain medical equipment, etc.) obtain both user-side responses and resource-side responses to respective sets of queries (e.g., survey questions), and use those responses to compute a compatibility metric. The computation includes applying a rule set, which maps candidate responses of the resource user to candidate responses associated with the resource, including at least one rule that defines a one-to many or many-to-many mapping, i.e., maps a candidate user-side response to two or more candidate resource-side responses, or maps a candidate resource-side response to two or more candidate user-side responses. The rule set also defines computational rules that are associated with particular mappings.

### TECHNICAL FIELD

The present disclosure generally relates to techniques for matching resource users to resources, and more particularly, to computationally efficiently techniques for accurately matching resource users to resources.

### BACKGROUND

In many fields, compatibility between resource users and resources is a key concern. In healthcare, for example, incompatibility between patients and healthcare providers (e.g., doctors, surgeons, physician assistants, etc.), or between patients and facilities having needed medical equipment, etc., can lead to patient attrition, patient and provider dissatisfaction, decreased healthcare utilization, and other serious problems. Particularly in the healthcare field, these problems are associated with huge potential costs. Current techniques are not very effective at mitigating these problems, as they tent do only determine whether very limited patient criteria are met (e.g., whether doctors have a particular specialty needed by a patient, or whether a clinic is located in the patient's vicinity).

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing environment in which various embodiments of the present disclosure can be implemented.

FIG. 2 depicts an example provider matching process.

FIG. 3 depicts an example provider matching process that incorporates a feedback/learning mechanism.

FIG. 4 depicts a flow diagram of an example computer-implemented method for accurately and efficiently assessing user-resource compatibility.

### DETAILED DESCRIPTION

As explained above in the Background, incompatibilities between resource users (e.g., patients) and resources (e.g., providers such as hospitals or doctors, or facilities that offer particular types of medical equipment, etc.) can create numerous problems (e.g., patient attrition, patient and provider dissatisfaction, decreased healthcare utilization, etc.) that are in turn associated with very substantial costs. Thus, there is a need for processes or tools that can be used to identify, with a high degree of accuracy, resources with which users will likely be compatible. However, matching resource users (also referred to herein as simply “users”) to resources can be challenging as the factors used to match them become more subtle and/or complex. For example, while it may be straightforward to match a patient who needs knee surgery to an orthopedic surgeon, or to match a patient at a particular address with a facility within a particular distance of that address, it can be difficult to match patients and resources based on more subjective and/or nuanced factors, such as factors relating to communication styles, philosophies, mannerisms, and so forth.

Matching can be especially challenging when there is an asymmetric relationship such as the relationship between resources and users of those resources. Unlike other areas that can benefit from matching techniques (e.g., matching for dating services/apps), the substantial differences in resource user and resource perspectives can make it impractical and/or unhelpful to ask both parties the same (or very similar) set of questions. For example, it may be more informative to ask a patient “Are you concerned that your doctor may become annoyed with you if you come to the visit with a lengthy list of questions?” while it may instead be more informative to ask a healthcare provider “Do you find that you are often able to provide better care to patients who engage in conversation with you?” Further, in some cases, there may not be a one-to-one correspondence between user-perspective questions and resource-perspective questions. In the above example, for instance, the user's response may be relevant to a provider response to the query “Do you encourage patients to avoid online research relating to their health?”, and also relevant to a provider response to the query “Do you find that you are often able to provide better care to patients who engage in conversation with you?”

Having different questions for the resource user and resource perspectives, combined with the possibility of a more complex correspondence between certain user and resource questions (e.g., many-to-one or one-to-many instead of one-to-one), can make straightforward “response matching” techniques insufficient. Further, given the exceedingly large number of instances in which such processes or tools may be desired, there is a need to automate such processes/tools in a manner that is computationally efficient and requires a relatively small amount of processing resources.

Accordingly, the present disclosure relates to automated or partially automated techniques (e.g., as implemented by hardware, software, machine-learned model(s), or a combination thereof, and/or process(es), etc.) for accurately and efficiently assessing compatibility between resource users and resources. Generally, the disclosed techniques obtain both user-side responses and resource-side responses to respective sets of queries (e.g., survey questions), and use those responses to compute a compatibility metric. The computation includes applying a rule set, which maps candidate responses of the user to candidate responses associated with the resource, including at least one rule that defines a one-to many or many-to-many mapping, i.e., maps a candidate user response to two or more candidate resource-side responses, or maps a candidate resource-side response to two or more candidate user responses. The rule set also defines computational rules that are associated with particular mappings. For example, a particular mapping may dictate adding a particular quantity to the compatibility metric (or to the numerator of an equation used to compute the compatibility metric, etc.) when responses for the user and resource match the respective candidate responses specified by that mapping. As another example, a mapping may dictate adding a particular quantity when (1) a response for the user matches a candidate response of the mapping, and (2) at least one resource-side response matches another candidate response of the mapping. Generally, the rule set may include any suitable sort of computational rules, such as adding to (or multiplying or otherwise increasing, etc.) the compatibility metric when a particular candidate user response was selected along with any one of a set of N candidate resource-side responses, when a particular candidate resource-side response was selected along with any one of a set of N candidate user responses, when a particular candidate user response was selected along with all responses of a set of N candidate resource-side responses, and so on. Particular rules of the rule set may also be conditional (e.g., dependent upon a response to one or more other user-side and/or resource-side queries), may specify that different quantities are added/used when there is a partial match versus a full match, and so on.

These techniques can accurately and efficiently determine attitudinal alignment between resource users and resource providers and/or predict how alignment/misalignment leads to user (and/or provider, etc.) satisfaction or dissatisfaction in real world settings/interactions (e.g., doctor visits or other healthcare encounters). In particular, the disclosed techniques can accurately determine alignment and/or predict the results of alignment/misalignment where user and resource perspectives are asymmetric in their substance (i.e., where the questions being answered differ significantly for the user and resource perspectives) and/or their number (e.g., where one user response is relevant to multiple resource-side responses and/or vice versa). The disclosed techniques enhance accuracy by using a defined rule set to guide the determinations, which can, for example, avoid the hallucinations that might result from simply using a large language model (LLM) to directly determine matching providers based on query responses or other user-side/resource-side input. The use of a rule set with mappings and associated computation rules also provides a computationally efficient solution, e.g., as compared to simply assessing all user-side/resource-side inputs with LLMs, which require many layers/nodes/etc. to achieve high accuracy, and which therefore have heavy processing requirements.

While examples discussed or shown herein refer primarily to the healthcare field with patients as resource users and healthcare providers as resources, it is to be understood that the disclosed techniques and embodiments can instead or additionally be applied to other types of resources (e.g., facilities that host particular kinds of medical equipment) and/or can be applied in other (non-healthcare) fields that involve resource users seeking resources (or resource-side entities seeking resource users, in some embodiments and/or scenarios). Moreover, as used herein, the term “user” or “patient” may refer to an established user or patient, or to a potential user or patient, and the term “provider” can refer to an individual (e.g., a doctor), an organization (e.g., a clinic, a hospital, etc.), or any other entity associated with the provision of services.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

### Example Computing Environment

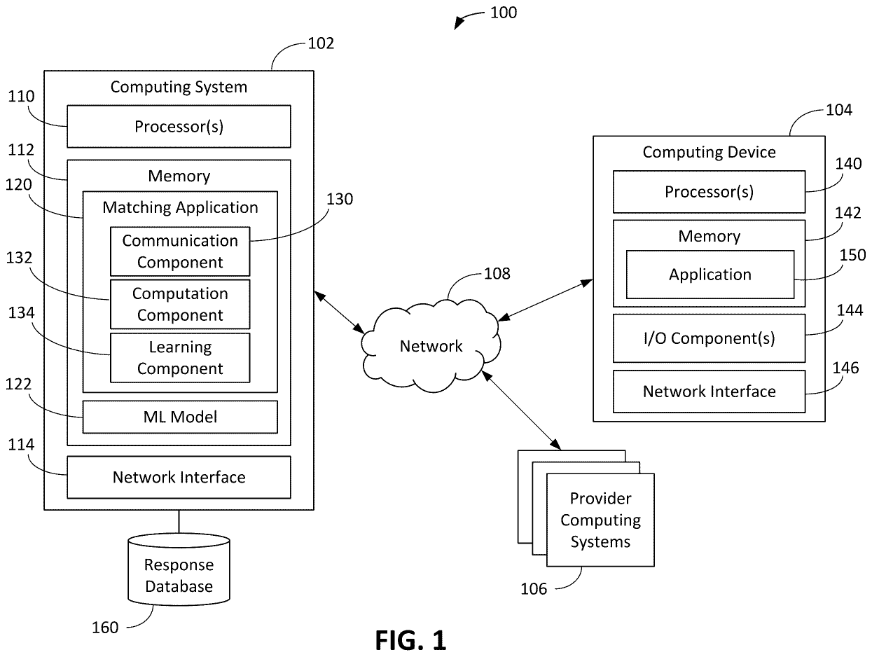

FIG. 1 depicts an example computing environment 100 in which various embodiments of the present disclosure may be implemented. Generally, the example computing environment 100 includes a computing system 102, a computing device 104, and a number of provider computing systems 106, some or all of which are communicatively coupled via a network 108.

Generally, the computing device 104 is associated with a user who may be seeking to benefit from or make use of a service of the type offered by (or otherwise associated with) the providers associated with provider computing systems 106. For example, the service may be a healthcare service such as primary care, or a particular type of surgery (e.g., orthopedic surgery, or more specifically knee surgery, etc.), and the provider computing systems 106 may be associated with (e.g., owned, maintained, and/or operated by) providers of that healthcare service. The computing system 102 may be associated with an organization that provides a service of matching service users to service providers. In some embodiments, the computing system 102 is associated with an entity that exclusively performs such a service. In other embodiments, the computing system 102 is associated with an entity such as a health insurance payor, a managed care organization, or any other suitable entity. In one alternative embodiment, at least some of the computing systems 106 are associated with facilities that provide a particular type or types of medical equipment (e.g., a magnetic resonance imaging (MRI) machine), and the computing device 104 is associated with a user who may be seeking to benefit from or make use of that medical equipment.

The computing system 102 may include a single server, or multiple servers that are co-located and/or remotely distributed, for example. In some embodiments, the computing system 102 provides matching services via a cloud platform (e.g., Amazon Web Services (AWS)®, Microsoft Azure®, or Google Cloud®). The computing system 102 includes one or more processors 110, memory 112, and a network interface 114.

The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute instructions (e.g., processor-executable code/instructions) stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 112 stores the processor-executable instructions of a matching application 120 and a machine-learned (ML) model 122, with the matching application 120 including a communication component 130, a computation component 132, and a learning component 134.

In some embodiments, the matching application 120 includes more, fewer, and/or different components, and/or the memory 112 may store more, fewer, and/or different components, than what is depicted in FIG. 1. In some embodiments, for example, the matching application 120 omits the learning component 134 and the memory 112 does not store the ML model 122. Additionally or alternatively, in some embodiments, some or all of the components that FIG. 1 shows as being stored in memory 112 are instead stored remotely, and are remotely accessed/used by the computing system 102. For example, the computing system 102 may remotely access the functionality of the matching application 120 and ML model 122 (or just access the ML model 122, etc.) via a cloud service provided by another entity and computing system.

The network interface 114 includes one or more hardware and/or software components that are generally configured to enable the computing system 102 to communicate, via the network 108, with other components and/or devices of the computing environment 100, such as the computing device 104 and provider computing systems 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and computing device 104, and one or more separate networks for communications between computing system 102 and provider computing systems 106, etc.).

The computing device 104 may be a desktop computer, a laptop computer, a tablet device, a mobile device, a wearable device (e.g., augmented or virtual reality glasses/headsets), or any other suitable computing device. The computing device 104 includes one or more processors 140, memory 142, one or more input/output (I/O) components 144, and a network interface 146.

The processor(s) 140 may include any suitable number of processors and/or processor types. In some examples, the processor(s) 140 include one or more CPUs, one or more GPUs, one or more TPUs, one or more FPGAs, one or more ASICs, and/or the like. Generally, the processor(s) 140 comprise hardware configured to execute instructions (e.g., processor-executable code/instructions) stored in the memory 142. The memory 142 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 142 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 142 stores the processor-executable instructions of an application 150, which may be, for example, a web browser application or a dedicated application (e.g., a matching application offered/provided by an entity associated with computing system 102).

The I/O component(s) 144 include hardware and/or software that generally enables a user of computing device 104 to interact with the computing device 104. The I/O component(s) 144 may include one or more input components that enable a user of computing device 104 to enter inputs to the computing device 104 (e.g., a keyboard, a microphone, etc.), one or more output components that enable the user to perceive outputs generated by the computing device 104 (e.g., a monitor/display, a speaker, a haptic feedback component, etc.), and/or one or more integrated I/O components (e.g., a touchscreen). The I/O component(s) 144 may use any suitable technology or technologies, such as LED, OLED, or LCD display technology, for example. While FIG. 1 shows computing device 104 as a single component communicating (via network 108) with the computing system 102, in some implementations the components of computing device 104 shown in FIG. 1 are instead divided among two or more client/user-side devices. As just one example, a pair of smart glasses may include one portion of the processor(s) 140, at least a portion of the memory 142, and a display of the I/O component(s) 144, while a smartphone may include another portion of the processor(s) 140, another portion of the memory 142, a touchscreen of the I/O component(s) 144, and the network interface 146. The smart glasses may then communicate as needed with the smartphone (e.g., via Bluetooth®) to enable the operations described herein.

The network interface 146 includes one or more hardware and/or software components that are generally configured to enable the computing device 104 to communicate, via the network 108, with other components and/or devices of the computing environment 100, such as the computing device 104. To this end, the network interface 146 includes hardware and/or software that operates in accordance with at least one communication protocol of the network 108.

While not explicitly shown in FIG. 1, one, some, or all of the provider computing systems 106 may have components (e.g., processor(s), memory, network interface, and possibly I/O component(s)) similar to computing system 102 or computing device 104.

The ML model 122 may comprise generative machine-learned model component(s), such as a transformer-based machine-learned model (e.g., a large-language model model (LLM), an embedding model, a diffusion model, and/or the like), and may additionally or alternatively comprise other machine-learned model component(s), such as neural network(s), decision tree(s), and/or the like. In some examples, the ML model 122 is trained to use text as input and to generate text or, in other embodiments, may be a multimodal LLM that operates upon and/or generates text and also other types of content (e.g., text, images, audio, etc.). The ML model 122 may receive a text prompt (referred to herein at times as simply a “prompt”) as an input, process the text prompt, and output text content responsive to the text prompt. The ML model 122 may additionally or alternatively include a deep neural network and may perform various natural language processing tasks as needed to understand a text query/prompt and generate a response to the text query/prompt, e.g., as part of a pre-processing operation and/or a post-processing operation. For example, in a pre-processing operation a neural network and/or another transformer-based machine-learned model may be trained to augment the original prompt to add sufficient context, which may be based on processing inputs determined from user and/or provider query responses, subsequent user and/or provider feedback, and/or the like, that is determined to be associated with the prompt. In a post-processing operation, the neural network and/or another transformer-based machine-learned model may be trained to review and alter, as necessary, an output of the transformer-based machine-learned model to be suitable for use by the learning component 134 to cause changes to queries and/or rules.

The ML model 122 may have a transformer-based model architecture that comprises an encoder that tokenizes the input and determines embeddings for the tokens, and a decoder that generates the output based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The ML model 122 may be a general-purpose model (e.g., trained on a wide array of publicly available datasets such as web pages, documents, etc., available via the Internet) such as a generative pre-trained transformer (GPT) 3.5, bi-directional encoder representations from transformers (BERT), or may be a domain-specific model (e.g., trained and/or fine-tuned on custom and/or proprietary datasets), such as a general purpose LLM trained using datasets of queries, responses, and user and/or provider feedback.

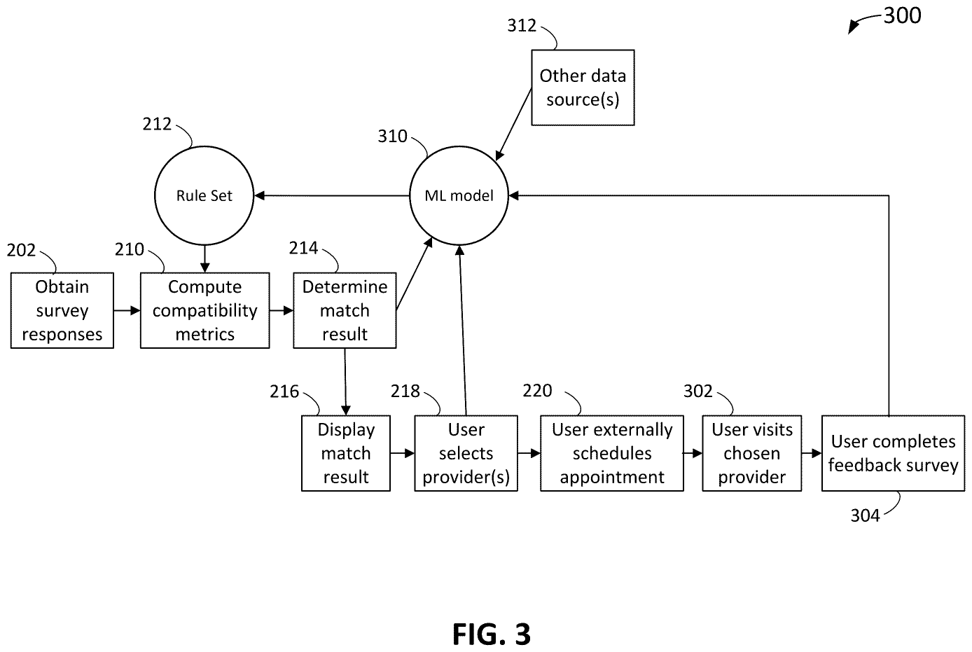

The functionality of learning component 134 and the operation of ML model 122 are described in further detail below in connection with FIG. 3, according to some embodiments.

In operation, in some embodiments and/or scenarios, the communication component 130 of matching application 120 provides a set of user queries to computing device 104, and a set of provider queries to provider computing systems 106 (e.g., the same set of provider queries to each of the provider computing systems 106, in some embodiments). The communication component 130 may provide the sets of queries in the form of online surveys, for example. As a more specific example, application 150 may be a web browser application, and the user of computing device 104 may use the web browser to access a website hosted by computing system 102, with a page of the website providing the set of user queries as well as interactive controls (e.g., radio buttons, sliders, fields for entering text, etc., that can be seen and manipulated via I/O component(s) 144) that enable the user to enter responses. As another example, application 150 may be a dedicated application (e.g., a downloadable/installable mobile app) offered by an entity associated with computing system 102, and the user of computing device 104 may use the dedicated application to view the set of user queries and to enter responses via the interactive controls. In some embodiments, similar techniques are used by communication component 130 to obtain provider query responses from the provider computing systems 106. Alternatively, different techniques can be used by communication component 130 to obtain user responses and provider responses. For example, communication component 130 may provide online surveys to obtain user responses, but instead obtain provider responses by scraping data/information from provider websites and using an LLM or other generative artificial intelligence (AI) model to infer or predict responses to the set of provider queries based on semantic (and/or other) content on the provider websites.

Communication component 130 may store obtained user and provider responses in a response database 160, which may be stored in memory 112 or another suitable memory (e.g., a secure, remote memory accessed via a cloud service/server). The stored responses may be used by computation component 132 to generate compatibility metrics and/or by learning component 134 (along with user and/or provider feedback) to update a rule set, both of which are discussed in further detail below.

The query sets for users and providers may include questions or other prompts that are expected to elicit, from the responder, information relevant to user-provider compatibility, in addition to (or instead of) information that merely identifies the specialty being sought or offered, cost-related information, and/or information relating to convenience (e.g., location, hours of operation, etc.). Given the different perspectives of users and providers, the user and provider queries relating to compatibility may pertain to different topics, even when the matching application 120 jointly considers those user/provider responses for compatibility purposes. For example, the (generally) different experiences, skills, expectations, philosophies, comfort levels, etc., of patients and doctors with respect to what makes a healthcare encounter a positive experience can make it unhelpful to ask the same question of patient and doctor (e.g., “Do you prefer to limit or avoid conversation that is not directly pertinent to the reason for the visit?”), or to ask questions that address the same topic and are merely mirror images of each other (e.g., “Do you prefer to limit or avoid conversation that is not directly pertinent to the reason for your visit?” and “Do you prefer to limit or avoid conversation that is not directly pertinent to the reason for the patient's visit?”). For example, research and/or experience (e.g., based on or supplemented by insights from behavioral science experts and/or clinicians) may show that it is more informative/helpful to ask a patient “Do you prefer a doctor who is outgoing/friendly?” while instead asking a doctor “Do you find that ‘small talk’ during an appointment distracts from your ability to focus on diagnosing/treating the patient?” and/or “Do you find it difficult to treat patients within the time constraints afforded by your practice?” In some embodiments, however, a subset of the user queries does match a respective subset of the provider queries or, if not an exact match, address the same topic(s) as the respective subset of the provider queries.

In some embodiments, different subsets of the user queries (and corresponding subsets of the provider queries) cover different domains/areas. In some embodiments, for example: (1) a first subset of user queries and a first subset of provider queries relate to clinical philosophy (e.g., views, preferences, capabilities, training, and/or experience relating to alternative medicine, treatments, and/or diets; views and/or preferences relating to vaccinations; views and/or preferences relating to the taking of prescribed medications; views and/or preferences relating to sharing with the provider the patient's historical medical records; etc.); (2) a second subset of user queries and a second subset of provider queries relate to bedside manner (e.g., views and/or preferences relating to communication style between patient and provider, such as humorous versus serious, extroverted versus introverted, concise versus comprehensive, direct versus indirect, assertive versus passive, analytical versus personal, functional versus intuitive, etc.; views and/or preferences relating to patients researching their own symptoms and/or preparing questions prior to a visit/encounter; views and/or preferences relating to who should lead the conversation during the visit/encounter; views and/or preferences relating to whether the provider or patient should be the ultimate maker of healthcare decisions for the patient; views, preferences, and/or capabilities relating to who should contact the patient from the provider's office; views, preferences, and/or capabilities relating to whether written summaries should be provided to the patient post-visit/encounter; views, preferences, and/or capabilities relating to the mode of patient-provider communication such as email, portal, instant messaging, or telephone; etc.); (3) a third subset of user queries and a third subset of provider queries relate to identity (e.g., views, preferences, and/or capabilities relating to gender-affirming and/or LGBTQ+-affirming care; views, preferences, and/or capabilities relating to body positivity; views, preferences, and/or capabilities relating to trauma-informed care; views, preferences, and/or capabilities relating to spirituality and/or spiritual care; views, preferences, and/or capabilities relating to veteran-informed support; views, preferences, and/or capabilities relating to substance use disorder-informed care; views, preferences, and/or capabilities relating to neurodivergent competency; views, preferences, and/or capabilities relating to deaf culture-informed care; views, preferences, and/or capabilities relating to HIV-centered care; views, preferences, and/or capabilities relating to immigrant care; views, preferences, and/or capabilities relating to care that empowers patients to make their own informed decisions and reverse harmful norms/stigma surrounding having a period; views, preferences, and/or capabilities relating to care that emphasizes openness, nonjudgmental attitudes, etc., regarding sexuality and sexual expression; views, preferences, and/or capabilities relating to care that holistically promotes healthy aging; etc.); and/or (4) clinic amenities/perks (e.g., views, preferences, and/or capabilities relating to offered services that are ancillary to the service the patient seeks, such as handicap parking, separate waiting rooms for patients, entertainment for children, etc.; views, preferences, and/or capabilities relating to communication services such as portals, direct messaging, online scheduling, nurse call line, etc.; views, preferences, and/or capabilities relating to contactless check-in, electronic prescription refill, and/or medical record sharing/use; views, preferences, and/or capabilities relating to house calls, inpatient rounding at hospitals, remote/video visits, interpreting services, onsite labs, and/or onsite imaging, etc.; views, preferences, and/or capabilities relating to care coordination services, integrated behavioral health services, integrated pharmacy services, etc.). In other embodiments, the queries may relate to more or fewer domains than the above example, or may not be divided/arranged by domain. Moreover, the domains of the queries may differ from those described above in one or more ways. In one embodiment, for example, the query domains include: (1) communication style preferences; (2) care approach preferences; (3) clinic amenity preferences; and (4) background and identity preferences.

The response to any given query may be a user-selected or provider-selected option from a fixed set of two or more candidate responses (e.g., “yes” or “no”, or “yes” or “no” or “undecided”, etc.). In some embodiments, however, some or all responses can take a different form. For example, the communication component 130 may use a machine-learned model (e.g., an LLM or classification neural network) not shown in FIG. 1 to process free-form text responses to one or more user queries and/or one or more of provider queries. In such an embodiment, a particular user query or provider query may be associated with a field in which the user or provider enters a free-form text response, and the communication component 130 may use a classifier (e.g., a recurrent neural network (RNN) such as a Long Short-Term Memory (LSTM) model, or a convolutional neural network (CNN), etc.) to classify the text response as one of a set of two or more available candidate responses. However, the efficiency (e.g., processing requirements) may benefit from not allowing such responses, or from limiting the number of queries that can be responded to with free-form text.

In some embodiments, for a given user (e.g., the user of computing device 104), the computation component 132 of matching application 120 calculates a different compatibility metric or score for each of some or all of the providers associated with provider computing systems 106, such that the compatibility metric for the user and a particular provider specifically indicates expected compatibility between that user and that provider. In such embodiments, the computation component 132 may reuse the same set of user query responses for each of some or all of the providers/metrics.

To compute a given compatibility metric, the computation component 132 applies a rule set that defines various mappings between candidate user responses and candidate provider responses, and further defines computational rules associated with those mappings. For example, the rule set may specify that, when a user provides Response A to Query 1 and a provider provides Response B to Query 2, the computation component 132 is to add a particular quantity (e.g., add one) to a numerator of the compatibility metric. As another example, the rule set may specify that, when a user provides Response A to Query 1 and a provider provides both Response B to Query 2 and Response C to Query 3, the computation component 132 is to add a particular quantity to a numerator of the compatibility metric.

The rules (i.e., mappings and associated computational rules) of the rule set can take a variety of forms, with a single rule set including rules that all have the same form or rules that have different forms, depending on the embodiment. As one example, a rule may define a one-to-many or many-to-one mapping of candidate responses, e.g., such that the computation component 132 does not add or use the quantity as specified by the associated computational rule unless the user selected a particular candidate response to a particular user query and the provider selected two or more particular candidate responses to two or more particular provider queries, or such that the computation component 132 does not add or use the quantity unless the provider selected a particular candidate response to a particular provider query and the user selected two or more particular candidate responses to two or more particular user queries, etc. The rule may specify that the computation component 132 is to apply the associated computational rule if and only if all of the mapped candidate responses were selected by the user or the provider. Alternatively, the rule may specify that the computation component 132 is to apply the associated computational rule if a candidate response (e.g., a candidate user response) is selected by one entity (e.g., the user) along with the other entity (e.g., the provider) selecting at least one of the mapped candidate responses (e.g., at least one of the candidate provider responses mapped to the candidate user response).

In some embodiments and/or some rules, a mapping and associated computational rule can indicate that the computation component 132 is to add or use one of two or more different quantities based on whether a partial match or full match exists. For example, the rule may specify that the computation component 132 is to add a smaller quantity (e.g., 0.5) if the user selected the candidate user response of the mapping and the provider selected a first candidate provider response of the mapping, and that the computation component 132 is to instead add a larger quantity (e.g., 1.0) if the user selected the candidate user response of the mapping and the provider selected a different, second candidate provider response of the mapping.

In some embodiments and/or some rules, a mapping and associated computational rule can indicate that the computation component 132 is to add a particular quantity based not only on whether the user and provider responses match the mapping, but also based on a response of the user to one or more other user queries, and/or based on a response of the provider to one or more other provider queries. For example, the rule may specify that the computation component 132 is to add a quantity (e.g., 1.0) to a numerator of the compatibility metric when a user provides Response A to Query 1 and a provider provides both Response B to Query 2, if and only if the user also provided a response (of any sort, or a specific response) to Query 3.

In some embodiments and/or some rules, the computation component 132 evaluates whether multiple mapped candidate provider responses were selected for a single user response, and determines whether to add or use a particular quantity in the compatibility metric for each of the mapped candidate provider responses that the provider selected. For example, a rule may specify that the computation component 132 is to add a first quantity (e.g., 1.0) to a numerator of the compatibility metric when a user provides Response A to Query 1 and a provider provides Response B to Query 2, that the computation component 132 is to add a second quantity (e.g., 0.5, or also 1.0, etc.) to the numerator when the user provides Response A to Query 1 and the provider provides Response C to Query 3, and that the computation component 132 is to add a third quantity (e.g., 1.5, or also 1.0, etc.) to the numerator when the user provides Response A to Query 1 and the provider provides Response D to Query 4.

The computation component 132 may also, or instead, apply any other suitable rule(s), including other types of mappings and/or computational rules. In some embodiments, computation component 132 applies different rule sets for different specialties (e.g., obstetrician/gynecologist, orthopedic, pediatric, etc.).

In some embodiments, when calculating a given compatibility metric, computation component 132 determines whether to add (or use as a multiplier, etc.) a particular quantity to the compatibility metric, or to a particular component of the compatibility metric (e.g., a numerator), on a user-query-by-user-query basis. For example, computation component 132 may in some embodiments proceed sequentially through the user responses, and update (or not update) the compatibility metric, or a component of the compatibility metric, based on whether each user response satisfies any rule or rules of the rule set.

In some embodiments, the quantities specified by the various computational rules are numbers that the computation component 132 is to add to a numerator (used to compute the compatibility metric) when the corresponding rule is satisfied. For example, the specified quantities may be viewed as “points,” and the computation component 132 may calculate the compatibility metric as a fraction by summing the points resulting from all of the satisfied rules/mappings, and then dividing that sum by a denominator equal to (or otherwise dependent on) the number/count of queries to which the user responded. Advantageously, in such embodiments, when a user responds to a particular query but the provider does not respond to one or more relevant/mapped provider queries, the result is that the denominator increases (in this example, by 1) without the numerator increasing, thereby having a lowering effect on the compatibility metric. Also advantageously, the user's decision to skip over particular queries (i.e., provide no response to one or more user queries) results in the user's other responses (and thus, other preferences/values/etc.) having more weight. For example, a user's views/preferences on 5 of 10 queries are weighted more heavily if the user responds to only those 5 queries than if the user responds to a higher number of (e.g., all 10) queries. The compatibility metric may be computed as a percentage, a normalized score (e.g., 0-1), or in any other suitable format. Moreover, in some implementations the compatibility metric may have multiple sub-metrics/components. For example, the compatibility metric may be a vector with elements/sub-metrics that are separately computed in the manner noted above for each domain (e.g., one for clinical philosophy, one for bedside manner, etc.).

The computation component 132 may implement and suitable rule set according to the principles discussed herein. Table 1 below represents one example of such a rule set:

TABLE 1

| Candidate User | Candidate Provider | |
|---|---|---|
| Response | Response | Computational Rule |
| UR1 | PR1 | Match = +1 |
| | PR2 | Match = +1 |
| UR2 | PR3 | Match = +1 |
| UR3 | PR4 | Match PR4 or PR5 or PR6 = +1 |
| | PR5 | |
| | PR6 | |
| UR4 | PR7 | Match = +0.5 |
| | PR8 | Match & Match UR4-PR7 = +1 |
| UR5 | PR9 | Match & Match UR2-PR3 = +1 |

Table 1 may be a portion of a rule set that is associated with a particular domain (e.g., bedside manner), for example. In Table 1, URx represents the x-th candidate user response and PRx represents the candidate x-th provider query response. While Table 1 does not depict the correspondence of candidate responses to queries, any suitable arrangement is possible. For example, UR1 and UR2 may be two alternative candidate responses to a first user query, and PR1, PR2, and PR3 may be three alternative candidate responses to a first provider query. As another example, UR1 may be a candidate response to a first user query, UR2 may be a candidate response to a second user query, PR1 and PR2 may be alternative candidate responses to a first provider query, and PR3 may be a candidate response to a second provider query.

As the term is used herein, a single “rule” can be viewed as a single computational rule and all associated mapping(s). For example, a first rule of the rule set of Table 1 may be viewed as: [UR1-PR1; Match=+1], where UR1-PR1 is the mapping associated with the first rule and “Match=+1” is the computational rule associated with the first rule. As another example, a second rule of the rule set of Table 1 may be viewed as: [UR3-PR4, UR3-PR5, UR3-PR6; Match PR4 or PR5 or PR6=+1], where the mapped pairs UR3-PR4, UR3-PR5, UR3-PR6 collectively form the mapping associated with the second rule and “Match PR4 or PR5 or PR6=+1” is the computational rule associated with the second rule.

As seen in the example of Table 1, the mappings and computational rules of a rule set may reflect different types of scoring, such as one-to-many (e.g., the user/provider selections need only correspond to one mapping pair to be a “match”), Boolean (e.g., the user/provider selections must satisfy all mapping pair(s) of a mapping to be a “match”), and/or a many-to-many match (e.g., for a single selected candidate user response, a separate/additional “match” can exist and result in a point for each of multiple candidate provider responses mapped to that single candidate user response).

Alternatively or additionally, the mappings and computational rules of a rule set may reflect conditional matching, where the computation component 132 evaluates whether a match exists based also on one or more conditional criteria, such as whether the user (or provider) selected a particular candidate response to a different query. In Table 1, an example “conditional match” rule maps UR5 to PR9, with the computational rule indicating that one point is added only if the mapped candidate responses were both selected and a match also exists for UR2-PR3 (i.e., UR2 and PR3 were also both selected).

Alternatively or additionally, the mappings and computational rules of a rule set may reflect partial matching, where the computation component 132 can add or use a lower or higher quantity depending on the degree of the match. In Table 1, an example “partial match” rule specifies that there is a partial match (add 0.5) when UR4 and PR7 were selected but PR8 was not selected, but a full match (add 1) when UR4, PR7, and PR8 were all selected.

In alternative embodiments and/or scenarios, rules of the rule set are keyed off of candidate provider responses rather than candidate user responses, and/or a single candidate provider response can be mapped to multiple candidate user responses.

In some embodiments, in addition to computing compatibility metrics for a user with respect to different providers, the computation component 132 or another component of matching application 120 assigns a rating (again, specific to that user) to each of one, some, or all of the providers. Rating a provider in this manner may include comparing the compatibility metric to one or more thresholds/values. In one example where the compatibility metric is a percentage value, for instance, the computation component 132 assigns a rating of “Good” when the compatibility metric for that provider is greater than or equal to 80%, a rating of “Fair” when the compatibility metric for that provider is greater than or equal to 50% and lower than 80%, and a rating of “Poor” (or no rating at all) when the compatibility metric for that provider is less than 50%. Other thresholds, and/or more or fewer bands/ratings, are also possible. In some embodiments where the compatibility metric includes multiple elements (e.g., a sub-metric for each domain of questions), the computation component 132 assigns a rating by comparing each of one, some, or all elements to a respective set of one or more thresholds, and applying suitable logic to determine an overall rating for the provider. Additionally or alternatively, in such embodiments, the computation component 132 may determine separate ratings for different domains.

In some embodiments, in addition to computing compatibility metrics for a user with respect to different providers (and possibly also rating those providers), computation component 132 or another component of matching application 120 performs further operations based on the compatibility metrics and/or ratings. For example, computation component 132 may rank the providers based on compatibility metrics, and/or determine a set of providers having the top N compatibility metrics (N being a suitable integer greater than or equal to one), etc.

The matching application 120 generates one or more data objects based on the result of the evaluation by matching application 120 (e.g., any one or more of the compatibility metrics, the ratings, the rankings, and/or the set of providers), such that the data object(s) reflect(s) that result. As used herein, reference to “generating” a data object can include creating an entirely new data object, or modifying/updating an existing data object. The data object(s) may include, for example, data having a particular data structure (e.g., within a structured query language (SQL) database, stored in association with an identifier of the user), or unstructured data (e.g., text within an unstructured data log).

The communication component 130 is configured to cause the result, or a portion of the result, to be displayed. For example, the communication component 130 may cause network interface 114 to transmit the data object(s) to computing device via network 108, for presentation to the user via application 150 and a display of I/O component(s) 144. In some embodiments, the application 150 provides a user interface that presents the result (e.g., compatibility metrics and/or ratings, provider rankings, provider list, etc.) to the user. In some embodiments, the user interface also provides information associated with the providers, such as locations/addresses, telephone numbers, and/or hours of operation. The user interface may also include interactive controls (e.g., one per provider indicated in the result) that enable the user to select a provider of interest, e.g., to cause the application 150 to open a landing page (web page) associated with a particular provider. In some embodiments, user selection of such an interactive control causes the application 150 to send data to matching application 120 via network interfaces 146, 114 and network 108, for use by learning component 134 to improve matching performance/accuracy over time, as discussed in further detail below in connection with FIG. 3.

It will be understood that the above disclosure, as well as those that follow, do not necessarily describe every possible embodiment. As such, it will be further understood that alternate embodiments may include fewer, alternate, and/or additional steps or elements.

### Example User-Provider Matching Processes

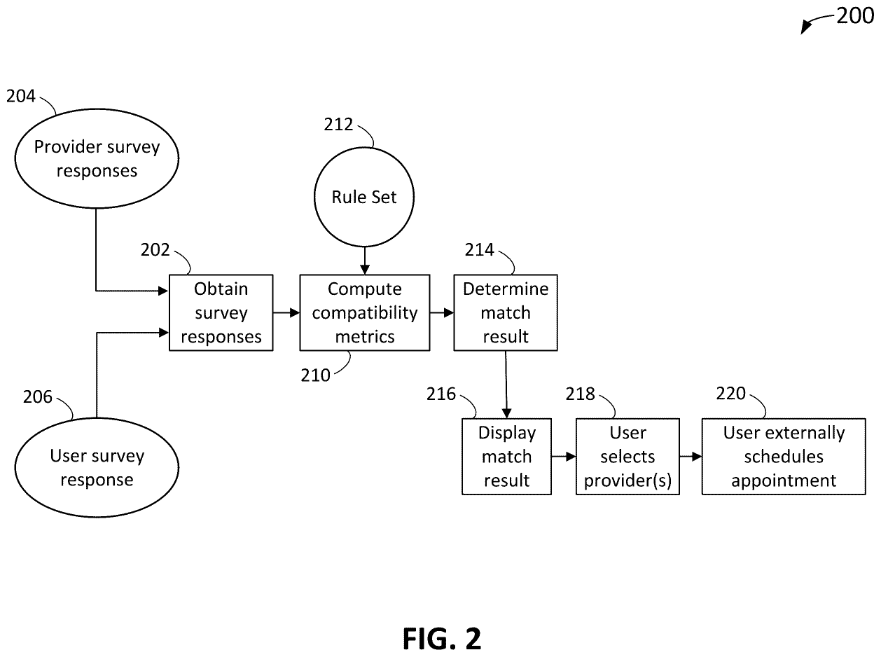

FIG. 2 depicts an example provider matching process 200, in accordance with various embodiments described herein. While the process 200 can be implemented in other suitable computing environments, the process 200 is described below with reference to elements/components of the computing environment 100.

At stage 202 of the process 200, provider survey responses 204 and user survey responses 206 are obtained by the communication component 130. Stage 202 may include communication component 130 obtaining the survey responses from the providers and/or the user via a website hosted by computing system 102, or by upload from provider computing systems 106 and computing device 104, etc. The provider survey responses 204 and user survey responses need not be (but may be) obtained at the same time, and may be obtained in either order, depending on the embodiment.

The provide responses 204 may be received, for example, from a number of providers completing provider surveys, by staff or agents on behalf of the providers, or by any other suitable entity that is able to obtain the information needed to provide accurate responses. In other example embodiments, the responses 204 are associated with a different type of resource, such as a facility, and the responses 204 may be provided by any suitable agent of the facility, etc.

The provider survey includes a number of provider queries, which may or may not be precisely the same for all providers. The provider queries may pertain to a number of different domains (e.g., clinical philosophy, bedside manner, identity-based care, clinical perks, etc.), or may not be divided by domain. The providers may complete the surveys by manipulating interactive controls to select particular candidate responses to one, some, or all of the queries. Stage 202 may include communication component 130 providing the survey to the providers (e.g., via a hosted website accessed by provider computing systems 106, or by download to provider computing systems 106, etc.), for example.

The user survey may be received from the user of computing device 104 (e.g., a patient), e.g., by the user manipulating interactive controls on a graphical user interface to select particular candidate responses to one, some, or all of the queries. In some embodiments, the user first selects a particular category or general type of resource (e.g., a particular specialty of a healthcare provider), and the user survey is specific to that category or general type. While the topics associated with the user queries may differ from the topics associated with the provider queries (even for queries that are mapped together by the rule set, as discussed above in connection with FIG. 1), the user and provider queries may cover the same general domain(s). Stage 202 may include communication component 130 providing the survey to the user (e.g., via a hosted website accessed by computing device 104, or by download to computing device 104, etc.).

In some embodiments, the user of computing device 104 and/or the providers associated with computing systems 106 create respective accounts in order to access and/or respond to the respective surveys. The account(s) may be specifically for a matching service provided by the entity associated with computing system 102, or may be account(s) that is/are also associated with other services. As one example, the user may create the account via application 150 (e.g., by accessing a website hosted by computing system 102, or by communicating with computing system 102 via a dedicated application such as a mobile app).

At stage 210, and using the user responses in conjunction with the respective set(s) of provider responses, the computation component 132 computes a respective compatibility metric for each of one, some, or all of the providers from whom survey responses were obtained at stage 202. Stage 210 includes applying a rule set 212 to the survey responses, with the rule set 212 defining one or more mappings and associated computational rules, e.g., as discussed above in connection with FIG. 1.

At stage 214, the computation component 132 (and/or another component of matching application 120) determines a match result (e.g., a recommendation for the resource user) based on the compatibility metric(s) for the one or more user-provider pairs. As the term is used herein, a match “result” may include any suitable number of distinct results (e.g., a set of multiple matching/recommended providers). In various embodiments, stage 214 may include rating providers based on their compatibility metrics, ranking providers, and/or determining a set of candidate providers whose compatibility metrics satisfy some criteria (e.g., exceeding a threshold compatibility metric value, falling within the top 10 ranking spots, etc.). In other embodiments, stage 214 merely includes assembling or collecting the various compatibility metric(s).

At stage 216, the communication component 130 transmits one or more data objects indicative of the match result to the computing device 104 (via network interfaces 146, 114 and network 108), which in turn causes application 150 to render the match result (or a portion of the match result) on a user interface presented by a display of I/O component(s) 144. Alternatively or additionally, the application 150 may cause one or more speakers of I/O component(s) 144 to generate an audio signal (e.g., using text-to-speech processing) for the user.

At stage 218, the user uses an interactive control of a user interface provided by application 150 to select one or more providers (e.g., one or more highest-ranked provider(s)) based on the displayed match result. Selection of a particular provider in this manner may cause the application 150 (or another source) to provide contact information (e.g., telephone number, street address, URL, etc.) for that provider, and possibly other information (e.g., hours of operation, etc.). The user may then contact a provider using the displayed contact information in order to schedule an appointment externally (e.g., through a scheduling mechanism of the chosen provider) at stage 220.

In other embodiments, when the match result is displayed at stage 216, the user is not presented with an option to select any provider(s). For example, the match result may show contact information for all providers in the match result, such that no further user selection is needed in order to contact a provider and schedule an appointment externally (e.g., through a scheduling mechanism of the chosen provider) at stage 220.

FIG. 3 depicts an example provider matching process 300, which may be the same as or similar to the process 200 but additionally incorporates a feedback/learning mechanism. While the process 300 can be implemented in other suitable computing environments, the process 300 is described below with reference to elements/components of the computing environment 100. Stages 202, 210, 214, 216, 218, 220 and rule set 212 of FIG. 3 may be similar to or the same as the like-labeled stages and rule set of the process 200.

At stage 302, the user (in this example, a patient) visits the chosen provider at the time of the scheduled appointment. At stage 304, which may occur after the visit of stage 302 (and/or after one or more follow-up visits with that provider), the user completes one or more feedback surveys that collectively include one or more user feedback queries. The user feedback queries may ask the user to rate the provider, for example, and/or may ask the user about the user's experience with respect to one or more specific topics. In some embodiments, the matching application 120 generates one, some, or all of the user feedback queries based on the user's responses to the initial survey as obtained at stage 202. For example, the matching application 120 may use an LLM not shown in FIG. 1 (locally stored, or accessible via a remote service) to generate one, some, or all of the user feedback queries based on one or more of the user's initial survey responses. In some embodiments, the matching application 120 inputs to the LLM a prompt that (1) includes or references/points to at least a subset of the user's responses to the initial survey, and (2) includes text instructions to devise a certain number of user feedback questions that specifically assess the user's satisfaction with respect to topics associated with those user responses. For example, if an initial user response indicates that the user prefers a humorous bedside manner, the LLM may generate a user feedback query asking whether the patient thought the doctor was funny (or too serious, etc.). As another example, if an initial user response indicates that the user wants trauma-informed care, the LLM may generate a user feedback query asking whether the patient thought the doctor was sufficiently attuned to the user's trauma-related issues or concerns.

The learning component 134 applies one or more types of feedback to an ML model 310. The ML model 310 may be the ML model 122 of FIG. 1, for example. Generally, as users use the matching service provided by computing system 102 over time, the learning component 134 can use outcomes (as reflected by that feedback) to learn how to refine the rule set 212 and/or the queries for better performance (e.g., more accurate user-provider matching). In the example shown in FIG. 3, for instance, the learning component 134 applies as inputs to the ML model 310 feedback that includes the match result from stage 214, an indication of the user's provider selection (or selections) at stage 218, and the user's response(s) to the user feedback survey(s) at stage 304. In other embodiments, the ML model 310 operates on only one of these types of feedback, on any two of these types of feedback, and/or on other types of feedback not shown in FIG. 3. Iterations of feedback and modification to the rule set and/or queries may continue over any number of users over any suitable window of time.

In some embodiments, the learning component 134 additionally or alternatively uses feedback or input from one or more other sources 312 to evaluate, retrain, and/or update the ML model 310. The other source(s) may include, for example, the user's computer device 104 or another device providing responses to one or more additional user surveys (e.g., a patient satisfaction after or otherwise independent of a post-visit survey associated with stage 304), a computing system that provides one or more other types of user data (e.g., patient claims data, patient scheduling data from one or more clinics indicating appointments with the same provider and/or other providers, etc.), a source of consumer research data, and/or any other suitable source or type of information that may be useful to inform the decisions or outputs of ML model 310.

One or more of these types of feedback may serve as ground truths for the ML model 310. For example, if feedback from stage 214 shows that Provider A was assigned a high compatibility metric and/or rating, but feedback from stage 218 shows that the user did not select (e.g., did not seek further information on, or did not start to schedule an appointment with, etc.) Provider A, learning component 134 may determine that the metric and/or rating was incorrect, and further train or fine-tune ML model 310 accordingly. As another example, if feedback from stage 214 shows that Provider A was assigned a high compatibility metric and/or rating, but feedback from stage 304 shows that the user was dissatisfied with Provider A (or in some embodiments, if the feedback shows the user was dissatisfied specifically with respect to an area of concern the user, as indicated in the user's initial survey responses obtained at stage 202), learning component 134 may determine that the metric and/or rating was incorrect, and further train or fine-tune ML model 310 accordingly.

The manner in which learning component 134 uses the output of ML model 310 to update the rule set 212 and/or (user and/or provider) queries can vary depending on the embodiment. For example, if the ML model 310 is an LLM, the learning component 134 may apply a prompt that instructs the ML model 310 to modify/update the rule set 212 and/or one or more queries from the initial user and/or provider surveys based on the feedback, and/or to generate one or more new user and/or provider queries based on the feedback. In some embodiments, the ML model 310 operates jointly on feedback related to multiple users. For example, if a large number of users indicated (in response to their initial user surveys) that they want a “conversational” doctor, but also indicate in user feedback surveys that they thought their doctors were too serious, the ML model 310 may output a modified/updated version of the initial query to more explicitly focus on whether the user prefers a “serious” provider, or (e.g., if a confidence level associated with the ML model 310 output is below a threshold) the learning component 134 may remove the initial query entirely. In another example, for the same scenario but where the ML model 310 outputs weights, the learning component 134 modifies the computational rule associated with the “conversational” candidate user response (e.g., by lowering the quantity that the computational component 132 adds/uses when the associated mapping is satisfied).

In alternative embodiments, the rule set 212 and/or queries are instead (or also) manually updated based on one or more of the types of feedback shown in FIG. 3, and/or based on other types of feedback.

In some embodiments, users (e.g., the user of computing device 104) are additionally provided (e.g., by computing system 102) with experience surveys that pose queries relating to user satisfaction with the matching/recommendation process itself. For example, survey questions may ask whether the user thought there were too many questions, overly long or complex questions, overly invasive questions, and so on. Future queries may then be adjusted based on such user feedback, either manually or by an ML model (e.g., ML model 310).

It is understood that, while various techniques (including feedback techniques) described herein may be automated, it is preferable to include human review at various stages to ensure that desired values, philosophies, etc., are closely adhered to. For example, during development, maintenance, and refinement of the system, human oversight may be employed for developing the ML model 310 and the various algorithms, analyzing data sources and outcomes, and so forth.

### Example Computer-Implemented Method

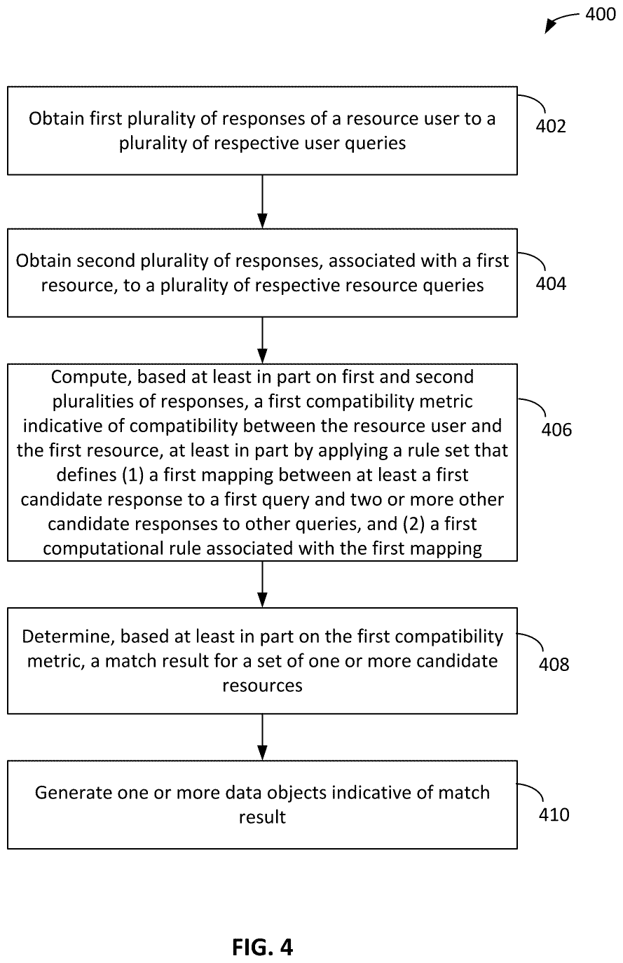

FIG. 4 depicts a flow diagram of an example computer-implemented method 400 for accurately and efficiently assessing user-resource compatibility. The method 400 may be implemented by processor-executable instructions of matching application 120 when executed by processor(s) 110, for example.

At block 402, a first plurality of responses of a resource user (e.g., the user of computing device 104) to respective user queries is obtained (e.g., by communication component 130). At block 404, a second plurality of responses to respective resource queries is obtained. The second plurality of responses is associated with a first resource (e.g., a service provider or other resource associated with one of computing systems 106). Blocks 402 and 404 may include operations of communication component 130 as described above in connection with FIGS. 1 and/or 2, for example. Block 404 may be repeated (i.e., other sets of responses may be obtained) for any number of other resources (e.g., for service providers associated with one or more other of the computing systems 106). In some embodiments, block 404 occurs before, or in parallel with, block 402.

At block 406, a first compatibility metric, indicative of compatibility between the user and the first provider, is computed (e.g., by computation component 132) based at least in part on the first and second plurality of responses. Block 406 includes applying a rule set that defines a first mapping between at least a first candidate response to a first query and two or more other candidate responses to other queries, and further defines a first computational rule associated with the first mapping. In some embodiments, the first query is one of the plurality of respective user queries and the other queries are included in the plurality of respective resource queries (i.e., at least one user query is mapped to at least two resource queries), while in other embodiments the first query is one of the plurality of respective resource queries and the other queries are included in the plurality of respective user queries (i.e., at least one resource query is mapped to at least two user queries). The rule set may also include one or more additional mappings with corresponding computational rules. The rule set may generally be arranged according to any of the embodiments (e.g., types of mappings and computational rules) discussed above in connection with FIG. 1, for example. Block 406 may be repeated (i.e., other compatibility metrics may be computed) for any number of other resources (e.g., for service providers associated with one or more other of the computing systems 106).

At block 408, a match result (e.g., recommendation) for a set of one or more candidate resources is determined (e.g., by computation component 132) based at least in part on the first compatibility metric, and possibly also additional compatibility metrics associated with (computed for) one or more other resources as noted above. The match result may include compatibility metric(s), rating(s), rankings, and/or a set of the candidate resources, e.g., as discussed above in connection with FIGS. 1 and/or 2.

At block 410, one or more data objects indicative of the match result are generated (e.g., newly created or updated/modified), e.g., by matching application 120. The data object(s) may include, for example, data having a particular data structure (e.g., within an SQL database, stored in association with an identifier of the user), or unstructured data (e.g., text within an unstructured data log).

The method 400 may repeat blocks 404 through 410 for one or more additional providers, and/or the method 400 may repeat in its entirety for one or more additional users (although not necessarily requiring block 404 to be repeated more than once).

It is to be understood that the operations of the method 400 may be performed in any suitable order (and/or in parallel), and/or may include fewer, additional, or different operations, in various embodiments.

### Examples

Example 1. A method for accurately and efficiently assessing user-resource compatibility, the method comprising: obtaining, by one or more processors, a first plurality of responses of a resource user to a plurality of respective user queries; obtaining, by the one or more processors, a second plurality of responses to a plurality of respective resource queries, where the second plurality of responses is associated with a first resource; computing, by the one or more processors and based at least in part on the first plurality of responses and the second plurality of responses, a first compatibility metric indicative of compatibility between the resource user and the first resource, at least in part by applying a rule set that defines: a first mapping between at least a first candidate response to a first query and two or more other candidate responses to other queries, wherein (i) the plurality of respective user queries includes the first query and the plurality of respective resource queries includes the other queries, or (ii) the plurality of respective user queries includes the other queries and the plurality of respective resource queries includes the first query; and a first computational rule associated with the first mapping; determining, by the one or more processors and based at least in part on the first compatibility metric, a match result for a set of one or more candidate resources; and generating, by the one or more processors, one or more data objects indicative of the match result.

Example 2. The method of Example 1, wherein computing the first compatibility metric includes: determining that the first mapping applies to at least a subset of the first plurality of responses in combination with at least a subset of the second plurality of responses; and in response to determining that the first mapping applies to at least the subset of the first plurality of responses in combination with at least the subset of the second plurality of responses, using a first quantity specified by the first computational rule to compute a numerator of a fraction.

Example 3. The method of Example 2, wherein computing the first compatibility metric includes determining a denominator of the fraction based on a count of the first plurality of responses.

Example 4. The method of any one of Examples 1-3, wherein a topic of the first query differs from all topics of the other queries.

Example 5. The method of any one of Examples 1-4, wherein the first computational rule specifies that a first quantity is used to compute the first compatibility metric when the first candidate response is selected and any one or more of the two or more other candidate responses are selected.

Example 6. The method of any one of Examples 1-4, wherein the first computational rule specifies that a first quantity is used to compute the first compatibility metric when the first candidate response is selected and all of the two or more other candidate responses are selected.

Example 7. The method of any one of Examples 1-4, wherein the first computational rule includes a conditional rule that is based at least in part on a response to a second query.

Example 8. The method of any one of Examples 1-4, wherein the first computational rule specifies that: a first quantity is used to compute the first compatibility metric when the first candidate response is selected and a first response of the two or more other candidate responses is selected; and a second quantity is used to compute the first compatibility metric when the first candidate response is selected and a second response of the two or more other candidate responses is selected.

Example 9. The method of any one of Examples 1-8, further comprising: causing, by the one or more processors, an indication of the match result to be displayed.

Example 10. The method of any one of Examples 1-9, wherein the first compatibility metric is one of a plurality of compatibility metrics associated with a plurality of respective resources, and wherein determining the match result includes ordering the plurality of respective resources based at least in part on the plurality of compatibility metrics.

Example 11. The method of any one of Examples 1-10, further comprising: modifying, by the one or more processors, one or more computational rules of the rule set, at least in part by using a machine-learned model to process resource user feedback.

Example 12. The method of any one of Examples 1-10, further comprising: modifying, by the one or more processors, one or more user queries and/or one or more resource queries, at least in part by using a machine-learned model to process user feedback.

Example 13. The method of Example 11 or Example 12, wherein the user feedback includes one or more resource user responses to one or more respective resource user feedback questions.

Example 14. The method of Example 13, further comprising: generating, by the one or more processors, the one or more respective resource user feedback questions based at least in part on the plurality of responses of the resource user.

Example 15. The method of Example 11, wherein the user input includes an indication of a particular resource selected by the resource user after the indication of the set of one or more candidate resources was displayed.

Example 16. The method of any one of Examples 1-15, wherein the plurality of respective resources includes one or both of: one or more service providers; and one or more facilities hosting a particular type of equipment.

Example 17. A system comprising: one or more processors; and one or more memories storing instructions that, when executed by the one or more processors, cause the one or more processors to perform operations comprising: the method of any one of Examples 1-16.

Example 18. One or more non-transitory computer-readable media storing instructions that, when executed by one or more processors, cause the one or more processors to perform operations comprising: the method of any one of Examples 1-16.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

1. A method for accurately and efficiently assessing user-resource compatibility, the method comprising:
obtaining, by one or more processors, a first plurality of responses of a resource user to a plurality of respective user queries;
obtaining, by the one or more processors, a second plurality of responses to a plurality of respective resource queries, the second plurality of responses being associated with a first resource;
computing, by the one or more processors and based at least in part on the first plurality of responses and the second plurality of responses, a first compatibility metric indicative of compatibility between the resource user and the first resource, at least in part by applying a rule set that defines:
a first mapping between at least a first candidate response to a first query and two or more other candidate responses to other queries, wherein (i) the plurality of respective user queries includes the first query and the plurality of respective resource queries includes the other queries, or (ii) the plurality of respective user queries includes the other queries and the plurality of respective resource queries includes the first query; and
a first computational rule associated with the first mapping;
determining, by the one or more processors and based at least in part on the first compatibility metric, a match result for a set of one or more candidate resources; and
generating, by the one or more processors, one or more data objects indicative of the match result.

2. The method of claim 1, wherein computing the first compatibility metric includes:
determining that the first mapping applies to at least a subset of the first plurality of responses in combination with at least a subset of the second plurality of responses; and
in response to determining that the first mapping applies to at least the subset of the first plurality of responses in combination with at least the subset of the second plurality of responses, using a first quantity specified by the first computational rule to compute a numerator of a fraction.

3. The method of claim 2, wherein computing the first compatibility metric includes determining a denominator of the fraction based on a count of the first plurality of responses.

4. The method of claim 1, wherein a topic of the first query differs from all topics of the other queries.

5. The method of claim 1, wherein the first computational rule specifies that a first quantity is used to compute the first compatibility metric when the first candidate response is selected and any one or more of the two or more other candidate responses are selected.

6. The method of claim 1, wherein the first computational rule specifies that a first quantity is used to compute the first compatibility metric when the first candidate response is selected and all of the two or more other candidate responses are selected.

7. The method of claim 1, wherein the first computational rule includes a conditional rule that is based at least in part on a response to a second query.

8. The method of claim 1, wherein the first computational rule specifies that:
a first quantity is used to compute the first compatibility metric when the first candidate response is selected and a first response of the two or more other candidate responses is selected; and
a second quantity is used to compute the first compatibility metric when the first candidate response is selected and a second response of the two or more other candidate responses is selected.

9. The method of claim 1, further comprising:
causing, by the one or more processors, an indication of the match result to be displayed.

10. The method of claim 1, wherein the first compatibility metric is one of a plurality of compatibility metrics associated with a plurality of respective resources, and wherein determining the match result includes ordering the plurality of respective resources based at least in part on the plurality of compatibility metrics.

11. The method of claim 1, further comprising:
modifying, by the one or more processors, one or more computational rules of the rule set, at least in part by using a machine-learned model to process resource user feedback.

12. The method of claim 1, wherein the plurality of respective resources includes one or both of:
one or more service providers; and
one or more facilities hosting a particular type of equipment.

13. A system comprising:
one or more processors; and
one or more memories storing processor-executable instructions that, when executed by the one or more processors, cause the one or more processors to perform operations comprising:
obtaining a first plurality of responses of a resource user to a plurality of respective user queries;
obtaining a second plurality of responses to a plurality of respective resource queries, the second plurality of responses being associated with a first resource;
computing, based at least in part on the first plurality of responses and the second plurality of responses, a first compatibility metric indicative of compatibility between the resource user and the first resource, at least in part by applying a rule set that defines:
a first mapping between at least a first candidate response to a first query and two or more other candidate responses to other queries, wherein (i) the plurality of respective user queries includes the first query and the plurality of respective resource queries includes the other queries, or (ii) the plurality of respective user queries includes the other queries and the plurality of respective resource queries includes the first query; and
a first computational rule associated with the first mapping;
determining, based at least in part on the first compatibility metric, a match result for a set of one or more candidate resources; and
generating one or more data objects indicative of the match result.

14. The system of claim 13, wherein the processor-executable instructions cause the one or more processors to compute the first compatibility metric at least in part by:
determining that the first mapping applies to at least a subset of the first plurality of responses in combination with at least a subset of the second plurality of responses; and
in response to determining that the first mapping applies to at least the subset of the first plurality of responses in combination with at least the subset of the second plurality of responses, using a first quantity specified by the first computational rule to compute a numerator of a fraction.

15. The system of claim 14, wherein the processor-executable instructions cause the one or more processors to compute the first compatibility metric at least in part by:
determining a denominator of the fraction based on a count of the first plurality of responses.

16. The system of claim 13, wherein a topic of the first query differs from all topics of the other queries.

17. The system of claim 13, wherein the first computational rule includes a conditional rule that is based at least in part on a response to a second query.

18. One or more non-transitory computer-readable media storing processor-executable instructions that, when executed by one or more processors, cause the one or more processors to perform operations comprising:
obtaining a first plurality of responses of a resource user to a plurality of respective user queries;
obtaining a second plurality of responses to a plurality of respective resource queries, the second plurality of responses being associated with a first resource;
computing, based at least in part on the first plurality of responses and the second plurality of responses, a first compatibility metric indicative of compatibility between the resource user and the first resource, at least in part by applying a rule set that defines:
a first mapping between at least a first candidate response to a first query and two or more other candidate responses to other queries, wherein (i) the plurality of respective user queries includes the first query and the plurality of respective resource queries includes the other queries, or (ii) the plurality of respective user queries includes the other queries and the plurality of respective resource queries includes the first query; and
a first computational rule associated with the first mapping;
determining, based at least in part on the first compatibility metric, a match result for a set of one or more candidate resources; and
generating one or more data objects indicative of the match result.

19. The one or more non-transitory computer-readable media of claim 18, wherein the processor-executable instructions cause the one or more processors to compute the first compatibility metric at least in part by:
determining that the first mapping applies to at least a subset of the first plurality of responses in combination with at least a subset of the second plurality of responses; and
in response to determining that the first mapping applies to at least the subset of the first plurality of responses in combination with at least the subset of the second plurality of responses, using a first quantity specified by the first computational rule to compute a numerator of a fraction.

20. The one or more non-transitory computer-readable media of claim 19, wherein the processor-executable instructions cause the one or more processors to compute the first compatibility metric at least in part by:
determining a denominator of the fraction based on a count of the first plurality of responses.

21. The one or more non-transitory computer-readable media of claim 18, wherein a topic of the first query differs from all topics of the other queries.
